(19) United States
(12) Patent Application Publication
(10) Pub. No.: US 2014/0250943 A1
(43) Pub. Date: Sep. 11, 2014

(54) AUTOMATED DEVICE FOR STORING, PRESERVING AND PROVIDING BAGS OF BLOOD

(71) Applicant: Agelantoni Life Science S.R.L. also known as ALS S.R.L., Massa Martana (PG) (IT)

(72) Inventors: Daniele Pericolini, Collelungo di Baschi (TR) (IT); Simone Ventura, Martino in Prignano Spoleto (PG) (IT); Dario De Angelis, Perugia (IT); Maurizio Ragni, Perugia (IT)

(73) Assignee: Angelantoni Life Science S.R.L. also known as ALS S.R.L., Massa Martana (PG) (IT)

(21) Appl. No.: 14/353,657

(22) PCT Filed: Oct. 11, 2012
(86) PCT No.: PCT/IB2012/055490

§ 371 Date: Apr. 23, 2014

(30) Foreign Application Priority Data
Oct. 24, 2011 (IT) MI2011A001919

(51) Int. Cl. A61J 1/16

(52) U.S. Cl. CPC A61J 1/165
USPC 62/441

(57) ABSTRACT

An automated device for storing, preserving and providing bags of blood comprises a control unit and a refrigerated cell containing a plurality of storage modules on top of one another. Each module comprises a storage disc which has on it a plurality of radially open compartments intended for housing the bags and it is equipped with a motor of axial rotation of the disc so as to bring, driven by the control unit, a selected compartment with its radial opening to a corresponding area for loading/unloading the bags. Advantageously, for each module the loading/unloading area comprises, towards the outside of the cell, an opening equipped with a door controlled electrically so as to allow or inhibit the access to the compartment brought to the area for loading/unloading through rotation of the disc.

The present invention refers to an automated device for storing, preserving and providing bags of blood.

Such types of devices are known for example from WO2005075006.

Known devices have the drawback of having a complex mechanical structure and/or of requiring a relatively complicated management in order to safely extract a bag of blood without the possibility of error. Such devices also often suffer from the fact that they require relatively frequent and onerous maintenance. Moreover, the idle time of the machine for maintenance or repairs is often long, especially in the case in which there is a failure of the internal mechanical movement system, and this forces there to be complicated manoeuvres in order to completely empty out the device, with the risks of error and of mixing up bags and of deterioration of the blood in the bags.

WO93/03891 discloses a storage apparatus with motorized annular shelves for specimens. A complex and expensive lifting device is provided for vertical insertion and removal of the specimens from an upper door. A sidewall of the apparatus may be provided with an access opening or a column of access openings, but these openings are for emergency use only, the openings being closed by plugs.

The purpose of the present invention is to avoid the aforementioned drawbacks, by providing an automated device having an innovative structure.

In view of such a purpose it has been thought to make, according to the invention, an automated device for storing, preserving and providing bags of blood comprising a control unit and a refrigerated cell containing a plurality of storage modules on top of one another, each module comprising a storage disc having a plurality of radially open compartments on it that are intended for housing the bags and being equipped with a motor of axial rotation of the disc to bring, driven by the control unit, a selected compartment with its radial opening to a corresponding area for loading/unloading the bags, for each module the area for loading/unloading comprises towards the outside of the cell an opening equipped with a door controlled electrically so as to allow or inhibit access to the compartment brought to the loading/unloading area.

In order to clarify the explanation of the innovative principles of the present invention and the advantages thereof with respect to the prior art we shall describe, with the help of the attached drawings, an example embodiment applying such principles. In the drawings:

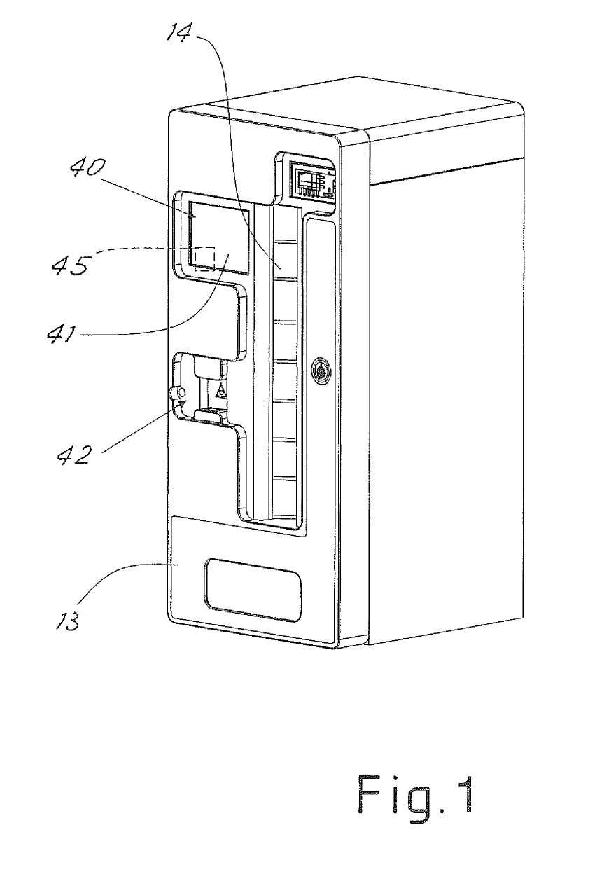

FIG. 1 represents a schematic perspective view of an automated device for storing, preserving and providing bags of blood made according to the invention;

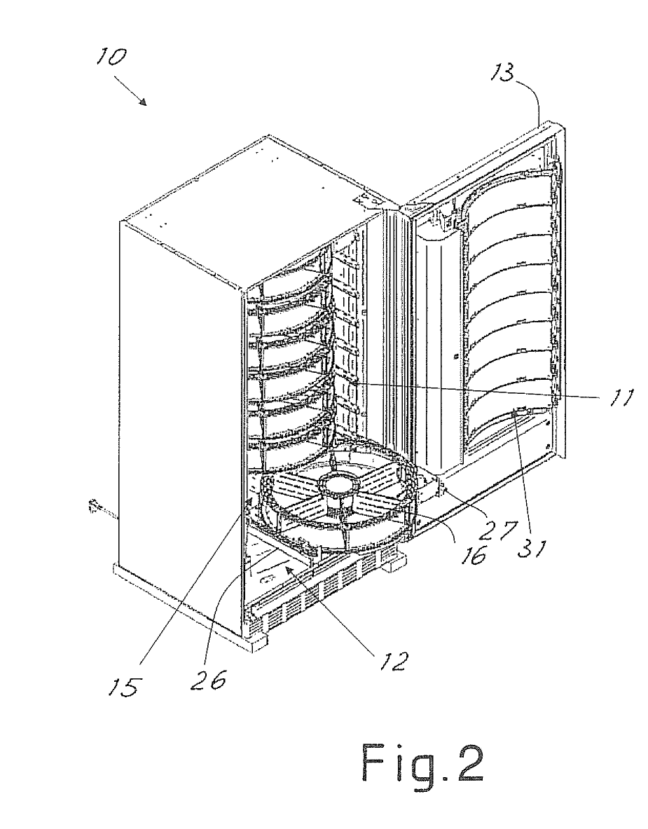

FIG. 2 represents a schematic perspective view of the device of FIG. 1, open;

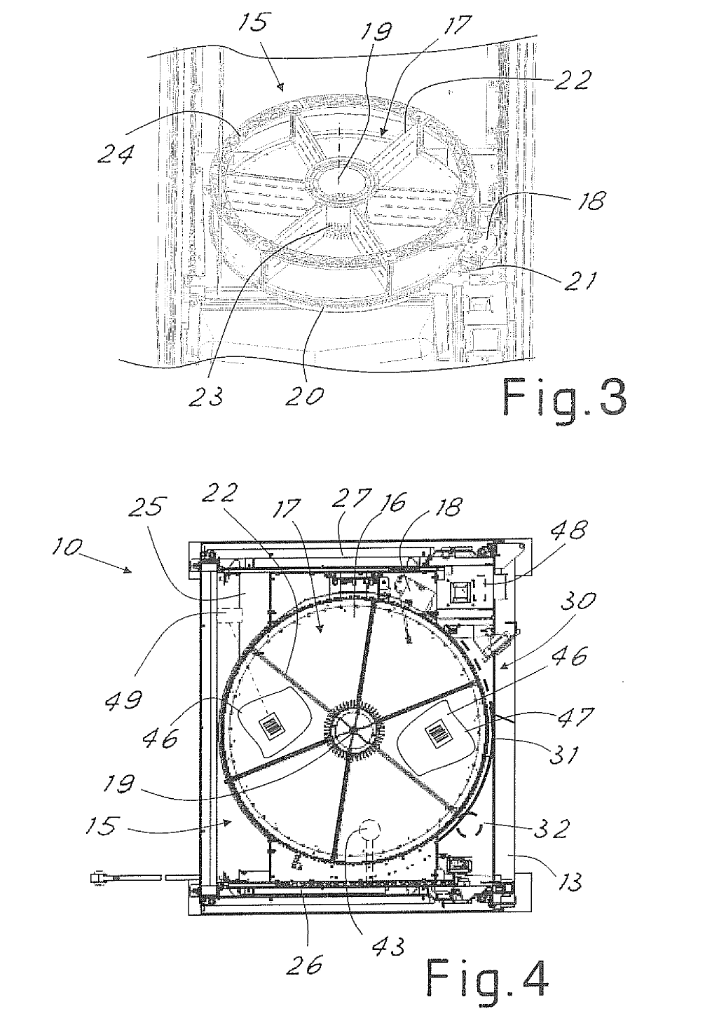

FIG. 3 represents a schematic perspective view from above of a module for storing the device of FIG. 1;

FIG. 4 represents a schematic view of a cross section of the device of FIG. 1;

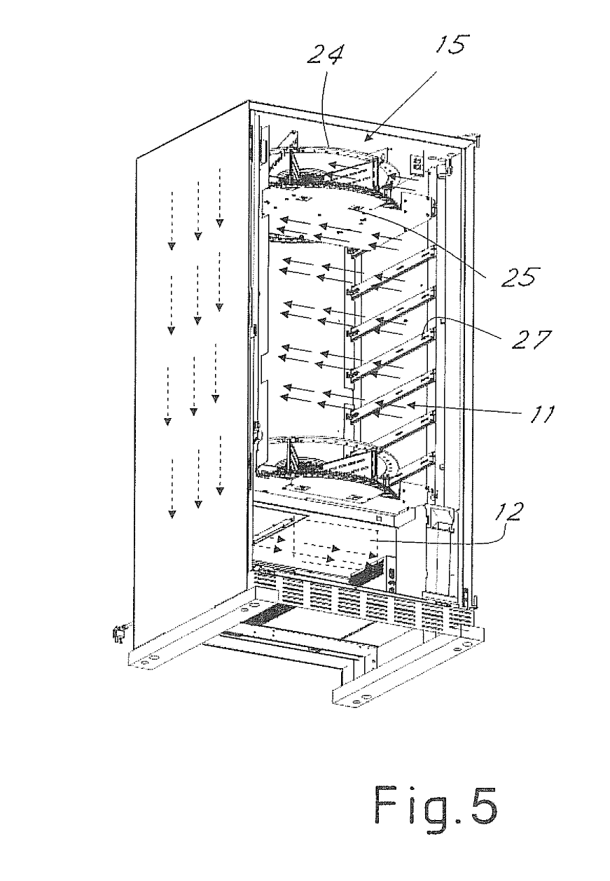

FIG. 5 represents a schematic view of the circulation of the cooling air inside the device of FIG. 1;

With reference to the figures, FIG. 1 shows an automated device, generally indicated with reference numeral 10, made according to the invention for the automated storing, preserving and providing of bags of blood.

As clearly visible also in FIG. 2, the device 10 internally comprises a cold-store 11 which is kept at a suitable temperature by means of a known refrigerating plant 12, which is not further illustrated or described since it is well known and can be easily imagined by a man skilled in the art.

The cell 11, closed by a service access door 13, houses the bags 46 to be stored.

During the normal operation of the device, the door 13 (which can advantageously be equipped with a safety lock) must not be opened and the device receives or gives out the bags only through suitable controlled openings 14.

As can be clearly seen also in FIG. 2, the refrigerated cell contains a plurality of storage modules 15, on top of one another, each comprising a rotary storage disc 16. For the sake of clarity, one of these modules is shown in the partially extracted position.

As can be clearly seen in FIGS. 3 and 4, the rotary disc of a module 15 has a plurality of compartments 17 on it that are opened at least radially (and, advantageously, also at the top) and that are intended for housing the bags to be conserved (for example a bag for each compartment).

Each disc is equipped with its own electric motor 18 of axial rotation of the disc around a central axis 19. The motor, or the disc, can be possibly provided with an encoder so as to precisely control the position through feedback.

Advantageously, the rotation movement is transmitted peripherally to the disc by means of a toothing 20 located on the circumferential edge of the disc and that is engaged by a corresponding gear 21 of the motor 18.

Advantageously, the compartments 17 are defined by lateral walls 22 (with holes or openings that are distributed on the surface so as to allow air to circulate, as shall become clearer in the rest of the description) and that are radially fixed in a removable manner onto the disc so as to be able to be moved, so as to be able to obtain compartments with different dimensions according to the specific storage requirements. In particular, the central axis of the disc can comprise seats 23 for engaging with the innermost edge of the wall, whereas the outermost edge can be fixed with screws into suitable holes on the disc 16 and on an upper counter ring 24. A light but sufficiently rigid and strong structure is thus obtained.

As can be clearly seen in FIG. 5, the rotating axis of the disc and the actuation motor are supported on a plate 25 which makes the bottom frame of each module 15.

As it is clear for example in FIG. 2 (where the lowest module is shown extracted), each module 15 is preferably supported in the cell in such a way as to be extractable in a drawer-like fashion by means of lateral sliding guides 26, 27 so as to be able to be extracted at least partially from the cell, so as to facilitate, for example, maintenance operations. Moreover, the module can be completely released from the guides so as to be removed and possibly replaced with a new module. This is particularly useful in the case in which there is a failure of a module, so as to reduce the idle time of the device and/or the time of opening the access door when the inside is refrigerated.

For the complete removal, the motor and the possible additional sensors present in the module are electrically connected to the rest of the device through suitable known connectors which can be disengaged.

Thanks to the aforementioned modular structure, a good forced circulation of cooling air can be obtained inside the cell through the modules in a horizontal direction from one side wall to the other, as shown by the arrows in FIG. 5 where the intermediate modules have been removed for the sake of clarity, with air circulating in the cooling plant below the cell to then be sent along perforated spaces in the side walls and through the modules. This makes it possible to have, throughout the store, a homogeneous temperature of the bags contained inside it.

With the structure described also the positioning of possible sensors for detecting the presence of bags in each compartment is facilitated, for example arranged in or below the floor of the compartment itself, as schematically indicated with 43 in FIG. 4.

A single fixed sensor (advantageously an optical or proximity sensor) placed in a suitable position in each module makes it possible to detect the presence of the bags in each compartment by simply making the storage disc rotate so as to bring all the disc compartments in sequence to the sensor.

As it is clear also in FIG. 4, the rotation of the discs in the modules makes it possible to bring, on command, the radial opening of a selected compartment to a corresponding area 30 for loading/unloading the bags.

Advantageously, for each module the loading/unloading area comprises, towards the outside of the cell, an opening 14 that is equipped with a door 31 that is controlled electrically so as to allow or inhibit access inside the compartment which has been brought to the loading/unloading, area through rotation of the disc.

The door (in FIG. 4 shown in the open position, with a full line, and in the closed position with a broken line) is advantageously made like a mobile semicircular partition that follows the peripheral outline of the corresponding rotating disc and that is slidingly moved in a circumferential direction to the storage disc thanks to an electrical motor 32 thereof (for example through a suitable movement through belts, not shown in detail since it can be now easily understood by a man skilled in the art) between the two positions, open and closed. With such a solution it is possible to adapt the width of the movement of the door according to the size of the compartment which must be accessed (size that is obtained by suitably arranging the mobile partitions). In such a way, there can also be compartments having different sizes on the same plate, by suitably setting the electronic control system so as to uncover a predetermined circumferential projection of the disc according to the width of the compartment 17 behind it brought to the loading/unloading area.

As can be clearly seen in the figures and, in particular, in FIG. 2, the openings for accessing the compartments are advantageously arranged on the door of the refrigerated cell.

For managing the operation, the device 10 comprises an electronic control unit (generically indicated with reference numeral 40 in FIG. 1) that comprises a user interface 41 (for example made with a touch screen display) for giving commands and for visualizing information.

The control unit 40 can be made with a computerised system per se known that is suitable programmed, as can be easily understood by a man skilled in the art based on the present description of the device.

Advantageously, the control unit comprises an electronic memory 45 for storing an association between data for recognising a specific compartment of a specific module and data for recognising a bag. In such a way, each time a bag is introduced in a compartment the control unit stores in said memory the association between the data for recognising such a compartment and the data for recognising such a bag. The data for recognising the compartment can comprise for example data on the angular position of the compartment on the disc. Such data can be provided by means of a per se known position control system, for example by using a stepper motor or an incremental or absolute encoder with a zero reference on the disc, as the rotation motor. Advantageously, the data for recognising each bag are arranged on the bag itself, for example by means of a label 47.

When the request for a bag is inserted in the control unit for providing a bag having specific recognition data (stored when the bag was introduced in the store), the control unit finds in the memory the data for recognising the compartment associated with such data for recognising the bag and drives the motor of the module to bring such a compartment to the inlet/outlet area, so as to allow the bag defined by the data for recognising contained or associated with the introduced request to be taken. For example, the request can be introduced by means of the interface 41, arrive from a remote data base system through a suitable data communication line, or also be introduced by means for reading a printed request or in any case stored on a suitable support.

Advantageously, the device 10 comprises a reader of data for recognising the bags, for acquiring and sending such data to the control unit when each bag is introduced. The data reader can be an optical scanner for bar codes and the data for recognising the bag can be contained in a bar code that is applied onto the bag itself. Alternatively, other known types of readers can be used, such as for example RFID readers or magnetic tape readers also according to the type of means 47 for retaining information which is preferred to be placed on the bags.

In the advantageous embodiment shown in FIG. 1, the reader (indicated with reference numeral 42) is placed externally on the machine (preferably in a space on the front door) so that the operator, when loading or unloading a bag, can make the system acquire the corresponding code of the bag by simply bringing the bag to the reader.

The reader can also be used by the system to acquire a request for a bag, that has been suitably coded by the computerised management system of the blood bank in a suitable support.

In such a way, an operator having the support with such a request only has to make the reader 42 read the request in order for the device 10 to identify and provide the correct bag. In the case in which bar code readers are used, the support with the request can be a simple piece of paper on which a bar code of the request has been printed. In more complex cases, the support can also he an electronic or magnetic card for a corresponding reader.

It can also be foreseen that, after emitting the bag, the operator necessarily needs to make the system read an identification code that is present on the bag so as to confirm that the correct bag has been emitted. In the case in which there is an error, the device can then indicate this acoustically and/or visually.

Also for the operations of loading a bag in the device it can preferably be set that the operator must pre-emptively make the system read the identification of the bag, so that the management system inside the device can automatically associate the particular bag to the compartment in which it is placed and subsequently allow the prompt and safe recovery of the bag through the memorised data, without requiring the access of other external data.

In order to read the information on the bag it is also possible to foresee a reader of such information arranged inside the machine, in a position that is suitable for a completely automatic reading. For example the reader can be arranged for reading the information of a bag transiting towards the inlet/outlet area or on a bag that is already in a compartment and has been brought to the reader thanks to the rotation of the disc, as schematically shown in 48 and 49 in FIG. 4, respectively.

At this point it is clear how the predetermined purposes have been achieved. The device described has a simple and modular structure. The inlet and outlet operations of the bags are easy, rapid and without errors. Moreover, thanks to the simple and modular structure faults are minimised and also in the case in which there is a failure or the need for maintenance, the idle time is minimised. For example, in the case of failure of a module it is sufficient to unload only such a module and to replace it with a new one, to then carry out repairs on the faulty module offline.

Of course, the description above of an embodiment applying the innovative principles of the present invention has been shown as an example of such innovative principles and must not therefore be used to limit the scope of protection claimed here.

1: Automated device for storing, preserving and providing bags of blood comprising a control unit and a refrigerated cell containing a plurality of storage modules on top of one another, each module comprising a storage disc having a plurality of compartments, each compartment having a radial opening and intended for housing bags of blood, each storage disc being equipped with a motor driven by the control unit and used for axial rotation of the disc to bring a selected compartment to a corresponding area for loading/unloading the bags of blood, the area for loading/unloading the bags of blood for each module comprising an opening defined in outer portion of the refrigerated cell and equipped with a door controlled electrically so as to allow or inhibit access to the selected compartment brought to the loading/unloading area.

2: The device of claim 1, wherein each door is motorised so as to slide in a circumferential direction to the corresponding disc so as to uncover a predetermined circumferential projection of the disc, wherein the extent of the projection is variable based on extent by which the door is slid so as to adapt the opening to width of the selected compartment brought to the loading/unloading area.

3: The device of claim 1, wherein the refrigerated cell is equipped with an access door and each module is supported in the cell on guides so as to be extractible at least partially from the cell via opening of said access door.

4: The device of according to claim 1, wherein the refrigerated cell is equipped with an access door on which said openings equipped with doors are arranged.

5: The device of claim 1, wherein for each disc the compartments are defined by mobile side walls removably fixed to the disc.

6: The device of claim 1, further comprising at least one sensor for detecting presence of bags of blood housed in the compartments as selected.

7: The device of claim 1, wherein the control unit comprises a memory for storing an association between first data for recognizing a specific compartment of a specific module and second data for recognising a bag of blood, wherein when each time a bag is introduced in a compartment, the control unit is configured to store in said memory the association between the first data for the compartment and the second data for the bag, and wherein when a request is inserted in the control unit for providing a bag of blood corresponding to the second data, the control unit is configured to find in the memory the first data for the compartment associated with the bag corresponding to the second data and is further configured to drive the motor of the corresponding module to bring such compartment to the loading/unloading area so as to allow the bag corresponding to the second data contained in the request, to be taken.

8: The device of claim 7, further comprising a reader of the second data for for acquiring and sending such data to the control unit.

9: The device of claim 8, wherein the data reader is an optical scanner for bar codes and the second data is contained in a bar code placed on the bag corresponding to the second data.
